(19) United States
(12) Patent Application Publication
(10) Pub. No.: US 2024/0150914 A1
(43) Pub. Date: May 9, 2024

(54) An electrolyzer comprising a heating apparatus

(71) Applicant: Smoltek AB, GÖTEBORG (SE)

(72) Inventors: Vincent Desmaris, GÖTEBORG (SE); Fabian Wenger, GÖTEBORG (SE)

(21) Appl. No.: 18/548,963

(22) PCT Filed: Mar. 10, 2022
(86) PCT No.: PCT/EP2022/056237

§ 371 Date: Sep. 5, 2023

(30) Foreign Application Priority Data
Mar. 19, 2021 (SE) 2130077-7

(51) Int. Cl. C25B 15/021; C25B 9/19

(52) U.S. Cl. CPC C25B 15/021; C25B 9/19

(57) ABSTRACT

An electrolyzer comprising a first and a second electrode and an ion exchange membrane arranged in-between the first and the second electrode. Each electrode comprises an electrically conductive element. At least one of the electrodes also comprises a catalyst structure comprising an electrically conductive material. The electrolyzer also comprises at least one feeding means, wherein the feeding means is arranged to introduce a variable electromagnetic field into the electrolyzer. The variable electromagnetic field is arranged to create a temperature gradient in the electrolyzer by increasing a temperature of the catalyst structure.

### TECHNICAL FIELD

The present disclosure relates to devices and methods used in electrolysis.

### BACKGROUND

The production of hydrogen gas through the electrolysis of water is a promising technology both for replacing the production of hydrogen gas from fossil fuels and as a means of converting excess electrical energy from intermittent energy sources such as solar and wind power to chemical energy for storage. However, existing water electrolyzers suffer from problems related to the use of expensive catalysts to promote the chemical reactions comprised in the electrolysis process. Catalysts lower the energy barrier of the chemical reactions, enabling them to occur at a rate that is sufficient for the electrolyzer to operate efficiently.

Another way of influencing the reaction rate is to increase a temperature at which the reactions take place.

U.S. Pat. No. 7,891,188 B2 discloses methods for increasing a temperature in an electrolyzer.

U.S. Pat. No. 7,645,930 B2 also discloses methods for controlling a temperature in an electrolyzer.

Still, there is a need for further improved electrolyzers.

### SUMMARY

It is an object of the present disclosure to provide an improved electrolyzer with means of increasing a temperature in the electrolyzer. This object is at least in part obtained by an electrolyzer comprising a first and a second electrode and an ion exchange membrane arranged in-between the first and the second electrode. Each electrode comprises an electrically conductive element. At least one of the electrodes also comprises a catalyst structure comprising an electrically conductive material. The electrolyzer also comprises at least one feeding means arranged to introduce a variable electromagnetic field into the electrolyzer. The variable electromagnetic field is arranged to create a temperature gradient in the electrolyzer by increasing a temperature of the catalyst structure.

Advantageously, creating a temperature gradient in the electrolyzer by increasing a temperature of the catalyst structure allows for localized heating of the catalyst where the chemical reactions take place, which can lead to the reactions occurring at a higher rate. Meanwhile, other parts of the electrolyzer may be kept at a lower temperature, thereby mitigating the risk of increased corrosion due to the higher temperatures.

The water introduced into the electrolyzer is frequently heated beforehand, often to around 80° C. By creating a temperature gradient in the electrolyzer, it may also be possible to reduce the temperature to which the incoming water is heated. This is an advantage, e.g., because it lowers the amount of energy that needs to be spent on heating the water.

According to aspects, the variable electromagnetic field is a propagating electromagnetic wave. Advantageously, a propagating electromagnetic wave may be guided to a specific position in the electrolyzer in order to achieve localized heating at the specific position. The frequency of the propagating electromagnetic wave may be selected to achieve a specific desired type of heating effect and/or an efficient heating of a specific part of the electrolyzer.

The feeding means may comprise a microwave applicator, a waveguide, a transmission line, and/or an optical fiber, depending on the frequency of the propagating electromagnetic wave.

According to some aspects, at least one feeding means may be positioned in connection to at least one of the electrically conductive elements. Advantageously, this allows for inserting the propagating electromagnetic wave near the electrically conductive element and achieving localized heating in this region. If localized heating on only the anode side or only the cathode side of the electrolyzer is desired, this can be achieved by arranging a feeding means in connection to the electrically conductive element on that side only.

According to other aspects, at least one feeding means may be positioned in connection to the ion exchange membrane. Advantageously, this makes it possible to direct the propagating electromagnetic wave to the ion exchange membrane and the parts of the catalyst structure that are closest to the ion exchange membrane. In particular, propagating electromagnetic waves with frequencies that are not strongly absorbed by the materials comprised in the ion exchange membrane may propagate through the membrane, thereby reaching parts of the catalyst structure that are far from the edges of the electrolyzer cell.

The propagating electromagnetic wave may comprise a frequency component between 300 MHz and 300 GHz. Radiation comprising frequency components in this frequency range are able to propagate through some parts of the electrolyzer cell, such as the ion exchange membrane, which is an advantage.

According to aspects, the propagating electromagnetic wave is a surface wave. Advantageously, a surface wave may be confined to only one surface in the electrolyzer, for example the surface of an electrically conductive element in one of the electrodes. This makes it possible to heat only one side of the electrolyzer cell.

According to aspects, the propagating electromagnetic wave comprises a frequency component corresponding to a plasmon frequency of the catalyst structure. When an object is exposed to an electromagnetic wave at a plasmon frequency of the object, it efficiently absorbs energy from the electromagnetic wave, leading to an increase in temperature. Thus, if the propagating electromagnetic wave comprises a frequency component corresponding to a plasmon frequency of the catalyst structure it has the advantage of efficiently heating the catalyst structure.

Optionally, if the catalyst structure comprises catalyst particles, the plasmon frequency may be a plasmon frequency of the catalyst particles. This has the further advantage of directly heating the catalyst particles where the chemical reactions comprised in the electrolysis process take place.

The catalyst structure may also comprise a plurality of nanoantennas, and the plasmon frequency may be a plasmon frequency of said nanoantennas. Advantageously, the nanoantennas may be designed to have a desired plasmon frequency. A desired plasmon frequency may be a frequency at which some component of the electrolyzer, such as the ion exchange membrane, is transparent to electromagnetic waves.

According to some aspects, the variable electromagnetic field is an alternating electric field. Advantageously, an alternating electric field can cause heating of electrically conducting components of the electrolyzer cell through resistive heating. Optionally, the feeding means may comprise electrical leads connected to the electrically conductive elements. The electrical leads may be connected to a power source. This has the advantage of requiring minimal modifications of the electrolyzer.

According to aspects, the variable electromagnetic field is an alternating magnetic field, and the feeding means may comprise means for generating an alternating magnetic field. Advantageously, the alternating magnetic field can cause a temperature increase in any component comprising electrically conducting materials due to induced currents and resistive heating. Additionally, the alternating magnetic field does not need to be conducted to any specific part of the electrolyzer but can instead be applied to the entire electrolyzer cell.

The electrolyzer may further comprise a plurality of magnetic elements. Here, magnetic elements are elements comprising materials that display magnetic hysteresis, such as ferro- or ferrimagnetic materials. An advantage of incorporating magnetic elements is that the magnetic elements will show more efficient heating compared to non-magnetic materials when exposed to an alternating magnetic field, due to hysteresis loss.

Optionally, the magnetic elements may be comprised in the catalyst structure. This has the advantage of ensuring efficient heating of the catalyst structure in which the chemical reactions comprised in the electrolysis process take place. More optionally, if the catalyst structure comprises catalyst particles, the magnetic elements may also be catalyst particles. This has the further advantage of not requiring the addition of magnetic elements not already a part of the catalyst structure.

According to other aspects, the magnetic elements may be located in the ion exchange membrane. This has the advantage of causing a temperature increase in the ion exchange membrane and the parts of the catalyst structure that are directly adjacent to it.

The object is also achieved at least in part by a method for introducing a temperature gradient into an electrolyzer. The electrolyzer comprises a first and a second electrode and an ion exchange membrane arranged in-between the first and the second electrode. Each electrode comprises an electrically conductive element and at least one of the electrodes comprises a catalyst structure comprising an electrically conductive material. The method comprises arranging at least one feeding means to introduce a variable electromagnetic field into the electrolyzer and introducing the variable electromagnetic field into the electrolyzer using the feeding means. The variable electromagnetic field is arranged to create a temperature gradient in the electrolyzer by increasing a temperature of the catalyst structure.

Advantageously, creating a temperature gradient in the electrolyzer by increasing a temperature of the catalyst structure allows for localized heating of the catalyst where the chemical reactions take place, which can lead to the reactions occurring at a higher rate. Meanwhile, other parts of the electrolyzer may be kept at a lower temperature, thus mitigating the risk of increased corrosion due to higher temperatures.

The object is also achieved at least in part by an electrolyzer comprising a first and a second electrode and an ion exchange membrane arranged in-between the first and the second electrode. Each electrode comprises an electrically conductive element and at least one electrode comprises a catalyst structure. The ion exchange membrane comprises a heating means arranged to create a temperature gradient in the electrolyzer by increasing a temperature of the ion exchange membrane.

Advantageously, increasing the temperature of the ion exchange membrane will lead to heat flowing into the catalyst structure adjacent to the ion exchange membrane, which comprises the parts of the catalyst structure that contributes the most to the chemical reactions comprised in the electrolysis process.

According to aspects, the heating means is a heating coil. An advantage of using a heating coil is that it is a heating means with a low degree of complexity and that the level of heating can be easily adjusted. A thickness of the heating coil may be configured to be smaller than a thickness of the ion exchange membrane. This has the advantage of allowing the heating coil to be embedded into the ion exchange membrane without being in contact with the catalyst structure on either side of the membrane, which reduces the risk of electron transport between the catalyst structures occurring through the membrane.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where:

FIG. 1 schematically illustrates an electrolyzer,

FIG. 2 schematically illustrates a catalyst structure,

FIG. 3 schematically illustrates an electrolyzer comprising feeding means,

FIG. 4 schematically illustrates an electrolyzer comprising feeding means,

FIG. 5 schematically illustrates a heating arrangement, and

FIG. 6 is a flowchart illustrating methods.

### DETAILED DESCRIPTION

Aspects of the present disclosure will now be described more fully with reference to the accompanying drawings. The different devices and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

Although the following description is focused on electrolyzers suitable for the electrolysis of water, a person skilled in the art will realize that the devices and methods herein described can also be used for electrolysis of other liquids or gases, provided that the reduction and oxidation reactions comprised in the electrolysis process take place on the surface of a catalyst and that the electrodes are separated by an ion exchange membrane or other solid electrolyte.

An electrolyzer comprises two electrodes, of which one is the positively charged anode and one is the negatively charged cathode, and a medium which allows for transport of ions, known as an electrolyte. The electrodes are connected to a power supply which provides electrical energy, driving the electrolysis reaction.

In some electrolyzers, a solid electrolyte or ion exchange membrane is used as the ion transport medium. An ion exchange membrane is a material that can be traversed by ions. Since this material conducts ions it can also be known as an ionic conductor. Use of ion exchange membranes allows for a compact electrolyzer design, as well as good separation of oxygen and hydrogen gas, which is an advantage.

Since ions are charged particles, the conduction of ions through an ionic conductor results in an electrical current through the material. This should not be confused with an electrical current due to the conduction of electrons, as the ionic and electronic conductivity of a material are often very different. In particular, materials comprised in an ion exchange membrane are generally selected to have a low electronic conductivity and a high ionic conductivity, i.e., ions can move easily through the membrane while electrons cannot move easily through the membrane.

While both electronic and ionic conduction refer to the ability of a material to conduct an electrical current through the displacement of charged particles, the charged particles are electrons in the case of electronic conductivity and ions in the case of ionic conductivity. Due to, among other things, the significantly higher mass of the ions and differences in transport mechanisms, ions in an ionic conductor will generally have a lower mobility than electrons in a metal or semiconductor. This in turn leads to the ions in an ionic conductor being slower to respond to changes in an applied electric field compared to electrons in an electronic conductor.

Herein, whenever the ability to conduct ions is discussed, it will be referred to as ionic conductivity, in order to distinguish it from the more common type of electric conductivity that is due to the movement of electrons. Expressions such as electric, electrical, or electronic conductivity should therefore henceforth be interpreted as relating to the conduction of electrons.

In addition to electronic and ionic conductivity, the materials also have a thermal conductivity relating to their ability to conduct heat. Although heat conduction will occur within and between components of the electrolyzer cell, the thermal conductivity of each component will not be further discussed herein.

The ion exchange membranes used in electrolyzers can be categorized according to the ionic species moving through the membrane. Anion exchange membranes, AEM, conduct the negative anion, in this case the hydroxide ion, from the cathode to the anode. Proton exchange membranes, PEM, conduct the positive hydrogen ion or proton from the anode to the cathode. Both anion and proton exchange membranes may be permeable to water but minimize the amount of hydrogen and/or oxygen gas that travels between the electrodes.

During electrolysis, water enters the electrolyzer on the side of the ion exchange membrane where the anode is located. For a PEM electrolyzer, water molecules on the cathode side undergo the reaction:

2H₂O→4H⁺+O₂+4e⁻.

The electrons will enter the circuit connecting the two electrodes, the oxygen gas leaves the electrolyzer, and the protons will diffuse across the PEM to the cathode side, where they undergo the reaction:

4H⁺+4e⁻→2H₂.

In an AEM electrolyzer, the water molecules will instead first diffuse through the AEM to the cathode side, where the following reaction takes place:

2H₂O+2e⁻→2OH⁻+H₂.

The hydroxide ions will diffuse through the AEM and undergo the following reaction at the anode:

4OH⁻−4e⁻→O₂+2H₂O.

The abovementioned chemical reactions comprised in the electrolysis process are each associated with an energy barrier that must be overcome in order for the reaction to proceed. The energy barrier depends on both the type of reaction and the conditions under which the reaction takes place. Conditions may for example include an electric potential, particularly for reactions occurring at an electrode, or a pH value of a liquid in which the reaction takes place.

It is common practice to use catalysts to reduce the energy barrier. A catalyst is a material or chemical compound that facilitates a chemical reaction. An electrolysis catalyst will in general be comprised in one of the electrodes and be arranged to facilitate the chemical reactions taking place at that electrode. The anode- and cathode-side electrolysis catalysts will frequently comprise different materials. In particular, anode-side electrolysis catalysts often comprise iridium or iridium oxide, while cathode-side electrolysis catalysts often comprise palladium, platinum, and/or nickel.

In electrolyzers comprising ion exchange membranes, each electrode may thus comprise an electrically conductive element connected to the power source and an electrolysis catalyst that facilitates the chemical reactions comprised in the electrolysis process. The electrolysis catalyst may be in the form of discrete particles, henceforth referred to in this description as catalyst particles, in which case the electrode may also comprise a catalyst support structure that connects the electrically conductive element and the electrolysis catalyst, electrically and mechanically, while still being permeable to water and gases.

In general, the electrolyzer will also comprise a porous material known as a porous transport layer or gas diffusion layer. The porous transport layer is located between the conductive element and the catalyst structure. The porous transport layer will generally comprise electrically conductive materials, enabling it to maintain the electrical connection between the catalyst structure and the conductive element. The porosity of the layer also allows for mass transport of reactants and products such as water, oxygen gas, and hydrogen gas to and from the catalyst structure. Common materials used in the porous transport layer are carbon felt, carbon paper, metal foams such as nickel or titanium foam, and metal meshes such as titanium meshes. Other porous metallic materials may also be used.

In addition to providing an electrical connection between the electrically conductive element and the catalyst particles, the catalyst support may need to allow the reactants and products of the chemical reactions comprised in the electrolysis process, such as water, oxygen gas, and hydrogen gas, to flow to and from the catalyst particles. Therefore, catalyst supports frequently comprise highly porous materials or have gaps and holes that allow water and gases to pass through. The water flowing into the electrolyzer on the anode side will flow through the gaps or pores in the catalyst support structure, as will the oxygen and hydrogen gases that are produced in the reactions.

Herein, an electrically conductive element is an element that has a high electronic conductivity. A high electronic conductivity could be an electronic conductivity normally associated with metallic or semiconducting materials, or a conductivity of more than 100 (Ωm)⁻¹.

The rate of the chemical reactions can also be increased by increasing the temperature at which the reactions take place. However, increasing the temperature of the entire electrolyzer can also lead to an increase in unwanted reactions such as corrosion of the electrodes. In addition, it may require a significant amount of energy, e.g., if it entails heating all water that is introduced into the electrolyzer to the higher temperature.

An alternative would be to introduce a temperature gradient into the electrolyzer, such that the electrolysis catalysts where the reactions take place are maintained at a higher temperature than for example the electrically conductive elements in the electrodes or the water flowing into the electrolyzer.

Optionally, the increase in reaction rates that results from increasing the temperature of the electrolysis catalysts can be used to adjust the production rate of the electrolysis cell depending on the availability of electric power. If, for example, the electrolyzer is powered by intermittent power sources such as solar and wind power, the temperature of the electrolysis catalysts could be increased at a time when there is a surplus of electric power, allowing the electrolyzer to produce a larger amount of hydrogen during that time.

It is also possible that, by creating a temperature gradient in the electrolyzer, the temperature to which the incoming water is heated can be reduced below the value used today, which may be around 80° C. This is an advantage, e.g., because it lowers the amount of energy that needs to be spent on heating the water.

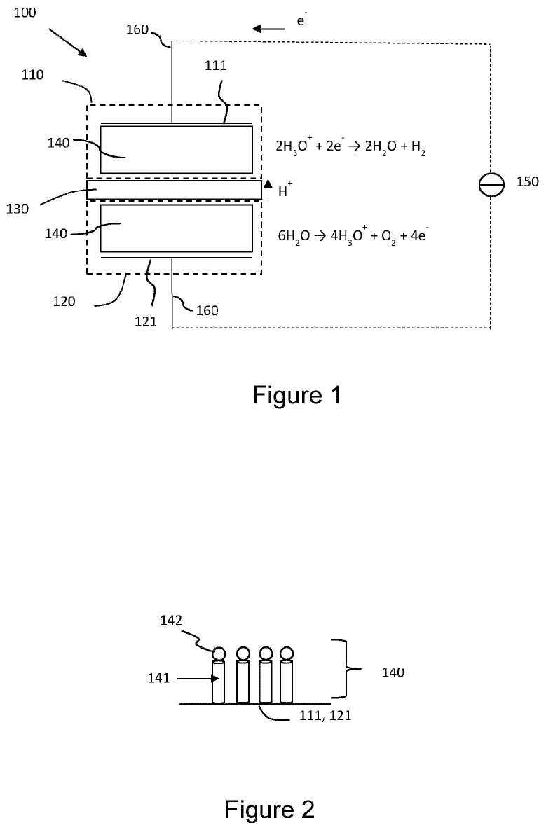

FIG. 1 shows an electrolyzer 100 comprising a first 110 and a second 120 electrode and an ion exchange membrane 130 arranged in-between the first and the second electrode, each electrode comprising an electrically conductive element 111, 121, at least one electrode comprising a catalyst structure 140 comprising an electrically conductive material. An electric potential is applied to the electrolyzer via the electrodes, for example by connecting the electrodes to a power source 150, in order to drive the electrolysis process.

Here, the electrically conductive elements 111, 121 comprise electrically conductive materials that can withstand the chemical environment in the electrolyzer. The electrically conductive elements 111, 121 may for example comprise materials such as titanium, tungsten, and/or zirconium. Optionally, an electrically conductive element may be a steel element coated with one or a combination of titanium, tungsten, and zirconium. An electrically conductive element may also comprise a carbon composite material.

The electrically conductive elements 111, 121 may be electrically conductive plates. A plate is taken to mean an object that is extended in two dimensions and comparatively thin in the third dimension. The electrically conductive elements 111, 121 may also be in the shape of a sheet, not necessarily planar, or other structure suitable for electrolysis.

The ion exchange membrane comprises ionic conductors, i.e., materials through which ions can travel. As an example, the ionic conductor may be a polymer such as sulfonated tetrafluoroethylene, also known as Nafion, or polymers based on polysulfone or polyphenol oxide. However, the ion exchange membrane may also comprise other types of ionic conductors, for example metal oxides such as doped barium zirconate, doped barium cerate, doped lanthanum gallate, or stabilized zirconia.

Some ionic conductors, especially polymers such as Nafion, may need to be hydrated, i.e., absorb water, in order to display a significant ionic conductivity.

The catalyst structure 140 may for instance comprise catalyst particles and a support structure for the catalyst particles, as discussed above. In general, the support structure needs to be able to conduct electricity, as electrons need to be able to travel from the electrically conductive elements 111, 121 to the catalyst particles where the chemical reactions take place. Additionally, the catalyst structure needs to be chemically stable under the conditions present in the electrolyzer.

The catalyst particles comprise materials that are catalytically active and promote the reactions taking place at the cathode and anode during electrolysis. As an example, the catalyst particles may comprise platinum, ruthenium, palladium, or iridium. The catalyst particles may also comprise metal oxides such as platinum oxide or iridium oxide. As another example, the catalyst particles may comprise cobalt or nickel. Optionally the catalyst particles may be nanoparticles, i.e., have a size that is substantially smaller than one micrometer and mostly between 1 and 100 nm. Preferably, the catalyst particles may be between 3 and 10 nm in size.

The support structure could for example have an electrical conductivity comparable to that of a metal or a semiconductor. Metallic materials such as a porous titanium mesh may be used. It is also common to use porous carbon, carbon paper, or materials comprising carbon fibers.

FIG. 2 shows an example catalyst structure 140 comprising a plurality of elongated nanostructures 141 arranged to connect the electrically conductive element 111,121 to a corresponding plurality of catalyst particles 142, where each catalyst particle 142 is localized at an end of a respective elongated nanostructure 141 opposite from the electrically conductive element 111,121. However, it should be noted that other configurations of the catalyst particles 142 are also possible. For example, the catalyst particles 142 may be deposited on the support structure in an arbitrary configuration, especially if porous carbon or a metallic mesh is used as a catalyst support structure.

In general, electrolysis catalyst particles 142 positioned close to the ion exchange membrane 130 contribute more to the electrolysis process compared to catalyst particles 142 positioned further away, as close proximity between the catalyst particle 142 and the ion exchange membrane 130 means that protons or hydroxide ions can more easily enter the ion exchange membrane.

The electrolyzer 100 may also comprise at least one feeding means, where the feeding means is arranged to introduce a variable electromagnetic field into the electrolyzer 100. The variable electromagnetic field is arranged to create a temperature gradient in the electrolyzer 100 by increasing a temperature of the catalyst structure 140.

According to one example, the variable electromagnetic field may be a propagating electromagnetic wave, or electromagnetic radiation. As an example, the propagating electromagnetic wave may comprise frequency components in the microwave spectrum, i.e., between 300 MHz and 300 GHz. As another example, the propagating electromagnetic wave may comprise infrared, visible or UV light.

There may be regulations in place that, e.g., limit the amount of power emitted or reserve certain frequency bands for specific applications. This is particularly the case for radio-frequency bands as well as the frequency bands between 1 and 300 GHz, which are frequently referred to as millimeter waves. The frequency components of the propagating electromagnetic wave may be selected so as to comply with such regulations in the country where the electrolyzer is used.

According to aspects, the frequency of the propagating electromagnetic wave may be selected such that the wavelength of the wave within the electrolyzer 100 is smaller than a size of the electrolyzer in the direction of propagation of the wave. Preferably, the wavelength may be at least ten times smaller than the size of the electrolyzer in the direction of propagation. It should be noted that the wavelength within the electrolyzer will depend on the dielectric properties of the material through which the electromagnetic wave propagates.

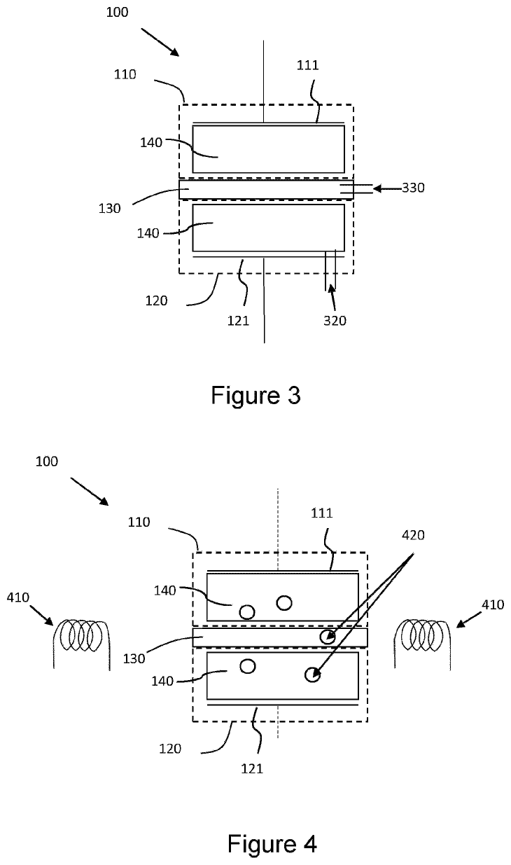

FIG. 3 shows the electrolyzer 100 with feeding means 320, 330 arranged in proximity to one of the electrically conductive elements 111, 121 and in connection to the ion exchange membrane 130. As an example, the feeding means 320, 330 may comprise one or more of a microwave applicator, a waveguide, a transmission line, and/or an optical fiber. The type of feeding means may be selected in dependence of the frequency of the propagating wave. As an example, if the propagating electromagnetic wave has a frequency in the microwave spectrum, a microwave applicator, transmission line, or a waveguide may be selected. In particular, transmission lines may be used at lower frequencies and waveguides may be used at higher frequencies. As another example, if the propagating electromagnetic wave comprises infrared, visible, or ultraviolet light, a feeding means comprising an optical fiber may be used.

At least one feeding means 320 may be positioned in connection to at least one of the electrically conductive elements 111, 121. For example, the feeding means may terminate in an aperture or slit in one of the electrically conductive elements 111, 121.

The propagating electromagnetic wave may be a surface wave. A surface wave is an electromagnetic wave that propagates at an interface between two materials with different dielectric properties. As the surface wave propagates along an interface, energy will be absorbed by the materials on either side of the interface, e.g., due to dielectric heating or due to the changing field causing electrical currents in the materials, which leads to resistive heating.

According to one example, a surface wave may be introduced into the electrolyzer 100 via a feeding means positioned in connection to at least one of the electrically conductive elements 111, 121. The surface wave may then propagate along the interface between the electrically conductive element and the volume occupied by the catalyst structure and the water or gas that comprises the reactants of the electrolysis process. Absorption of energy from the surface wave will cause an increase in the temperature of the electrically conductive element. As the electrically conductive element is in electrical and thermal contact with the catalyst structure 140, this will result in an increase in the temperature of the catalyst structure 140. Absorption of energy may also occur in the catalyst structure 140, directly leading to an increase in temperature of the catalyst structure 140.

The absorption of energy from the surface wave also depends on the penetration depth, i.e., how far into a material the electromagnetic fields from the surface wave can penetrate. The penetration depth is determined, among other things, by the mobility of charged particles such as electrons and ions in the material and the frequency of the surface wave. For electrically conducting materials such as those comprised in the electrically conductive elements 111, 121, the penetration depth can be on the order of micrometers, while the penetration depth in the volume occupied by the catalyst structure 140 varies depending on the conductivity of the catalyst structure 140 and the contents of the water or gas that comprises the reactants of the electrolysis process. In particular, on the anode side where water is present, the pH and ion content of the water may influence the penetration depth.

According to aspects, the frequency of the surface wave may be selected to achieve a desired penetration depth either for the electrically conductive element 111, 121 or for the volume occupied by the catalyst structure 140. According to other aspects, the frequency of the surface wave may be between 1 and 300 GHz.

According to one example, at least one feeding means 330 may be positioned in connection to the ion exchange membrane 130. In particular, the feeding means may be arranged to introduce the propagating electromagnetic wave into the ion exchange membrane 130.

As previously mentioned, the ion exchange membrane 130 may comprise polymers such as sulfonated tetrafluoroethylene, also known as Nafion, polymers based on polysulfone or polyphenol oxide, or other ion-conducting materials. These materials have a low electronic conductivity but conduct ions and may be polarized by electromagnetic fields.

In the electrolyzer, the ion exchange membrane 130 is sandwiched between two catalyst structures 140 comprising materials with a higher electronic conductivity, such as metal particles, metal meshes, and carbon materials. This layered structure can function as a waveguide for electromagnetic waves introduced into the ion exchange membrane 130. Said electromagnetic waves can then propagate along the ion exchange membrane 130.

A waveguide is a device arranged to conduct waves in a direction along the length of the waveguide. For electromagnetic waves with frequencies in the microwave spectrum and below, waveguides frequently comprise hollow structures with walls made of an electrically conducting material such as a metal enclosing a volume through which the electromagnetic wave can propagate. When an electromagnetic wave propagates in such a waveguide, the varying electric and magnetic fields cause electrical currents to flow in the electrically conducting surfaces of the waveguide. Due to resistive heating, this leads to an increase in the temperature of the waveguide walls.

In the case of electromagnetic waves propagating in the ion exchange membrane 130, the electrical currents will arise in the catalyst structure 140, raising the temperature of the catalyst structure and causing a temperature gradient in the electrolyzer 100. According to aspects, the propagating electromagnetic wave may comprise a frequency component above 300 MHz, and preferably it may comprise a frequency component between 1 and 300 GHz. According to other aspects, the propagating electromagnetic wave may comprise frequency components that are not strongly absorbed by the materials comprised in the ion exchange membrane.

Objects comprising materials that display an electrical conductivity comparable to that of a metal or a semiconductor may interact strongly with electromagnetic waves at certain frequencies, particularly if the object is a nanoscale object such as a nanoparticle, nanotube, or nanofiber. At these frequencies, the electromagnetic wave may give rise to a collective oscillation of the conduction electrons in the object, a phenomenon also known as a plasmon. The corresponding frequencies are therefore referred to as plasmon frequencies.

When exposed to electromagnetic waves at or near the plasmon frequency, the object may absorb a larger fraction of the energy of the electromagnetic wave compared to when it is exposed to electromagnetic waves at other frequencies. The absorbed energy is generally converted into heat, increasing a temperature of the object and its surroundings.

The catalyst structure 140 may comprise objects with different plasmon frequencies, such as nanoparticles, nanotubes, or nanofibers comprising electrically conducting materials. The strong interaction between such an object and an electromagnetic wave at the plasmon frequency can then be used to cause an increase in temperature of the catalyst structure, thereby creating a temperature gradient within the electrolyzer 100. Thus, the propagating electromagnetic wave may comprise a frequency component corresponding to a plasmon frequency of the catalyst structure 140.

A plasmon frequency of the catalyst structure 140 is here taken to mean a plasmon frequency of an object that forms part of the catalyst structure, such as a nanofiber or nanoparticle, or a plasmon frequency of the catalyst structure as a whole. Note that if different objects comprised in the catalyst structure have different plasmon frequencies, the propagating electromagnetic wave could be arranged to comprise several frequency components, each corresponding to the plasmon frequency of an object comprised in the catalyst structure.

The plasmon frequency of an object depends, i.a., on the electronic properties of materials comprised in the object, the shape of the object, and the size of the object. Electronic properties may for example be a density of so-called conduction electrons, which are electrons that are able to move through a material and conduct electricity.

It should be noted that the increased absorption of energy is not limited solely to the plasmon frequency but can also occur at frequencies close to the plasmon frequency. The ability of the object to absorb energy may be expressed as a frequency-dependent energy absorption efficiency function, which would then display a peak with a finite width centered around the plasmon frequency. The width of the peak depends, i.a., on the materials comprised in the object and on the object size and shape.

The electromagnetic wave may therefore be arranged to comprise frequency components in a frequency band encompassing at least some of the frequencies for which the energy absorption efficiency function displays a peak. The frequency band may be defined by a lower frequency limit and a higher frequency limit, optionally with the lower frequency limit being below the plasmon frequency and the higher frequency limit being above the plasmon frequency. As an example, the lower and higher frequency limits may be set in dependence of the width of the peak in the energy absorption efficiency function. As another example, the lower frequency limit may be the plasmon frequency times a factor of 0.9 and the higher frequency limit may be the plasmon frequency times a factor of 1.1.

According to aspects, the catalyst structure 140 may comprise catalyst particles 142 and the plasmon frequency may be a plasmon frequency of the catalyst particles 142. As previously described, catalyst particles 142 may be nanoparticles of a size below 100 nm and comprise catalytically active materials such as platinum, palladium, iridium, iridium oxide, or nickel. Particles comprising platinum, iridium, or palladium frequently have plasmon frequencies in the ultraviolet spectrum, while particles comprising nickel or iridium oxide may have plasmon frequencies in the visible or infrared spectrum.

According to other aspects, the catalyst structure 140 may comprise carbon nanostructures such as carbon nanofibers or carbon nanotubes, and the plasmon frequency may be a plasmon frequency of the carbon nanostructures.

Optionally, the catalyst structure may comprise a plurality of nanoantennas, and the plasmon frequency may be a plasmon frequency of said nanoantennas. Herein, a nanoantenna is taken to be a nanostructure such as a nanoparticle, nanotube, nanorod or nanofiber that is arranged to efficiently absorb electromagnetic waves of a specific frequency or in a specific frequency band. The nanoantennas can be arranged to absorb electromagnetic waves of a frequency that is not efficiently absorbed by the catalyst particles 142 or the catalyst support structure.

Optionally, the nanoantennas may be arranged in close proximity to the catalyst particles 142, such that heat can easily flow from the nanoantennas to the catalyst particles 142.

According to an example embodiment and with reference to FIG. 3, the ion exchange membrane 130 may comprise a material that is at least partially transparent to electromagnetic waves in the infrared, visible, or ultraviolet spectra. As an example, sulfonated tetrafluoroethylene, also known as Nafion, is at least partially transparent in the visible and infrared spectra.

In this embodiment, the electrolyzer 100 may comprise feeding means 330 arranged in connection to the ion exchange membrane 130, such that the propagating electromagnetic wave is introduced into the ion exchange membrane. The feeding means may be adapted to introduce a propagating electromagnetic wave of a frequency at which the ion exchange membrane 130 is at least partially transparent. For example, the feeding means may comprise an optical fiber.

The catalyst structure 140 may comprise a plurality of objects that have plasmon frequencies at which the ion exchange membrane 130 is at least partially transparent. The objects may for example be the catalyst particles 142 or parts of the catalyst support structure. The objects may also be nanoantennas.

Thus, in this embodiment, the propagating electromagnetic wave comprises a frequency to which the ion exchange membrane is at least partially transparent and that corresponds to a plasmon frequency of the catalyst structure 140. The propagating electromagnetic wave can be introduced into the ion exchange membrane 130 through the feeding means 330 and propagate through the ion exchange membrane. The propagating electromagnetic wave can thus reach the catalyst structure 140 which is positioned adjacent to the membrane. Within the catalyst structure 140 the propagating electromagnetic wave may then be absorbed by parts of the catalyst structure that have a corresponding plasmon frequency, such as catalyst particles or nanoantennas. This gives rise to an increase in temperature of the catalyst structure, thus creating a temperature gradient in the electrolyzer 100.

The variable electromagnetic field may be an alternating electric field. An alternating electric field causes currents to flow in electrically conducting materials comprised in the electrolyzer 100. This will cause the temperature of the electrically conducting materials to increase due to resistive heating. As the catalyst structure 140 comprises electrically conducting materials, its temperature will increase due to the alternating electric field.

The ion exchange membrane 130 will also be affected by an alternating electric field since it also conducts an electric current, although as previously mentioned the charged particles that are being transported are ions rather than electrons. Resistive heating can therefore occur also in the ion exchange membrane. The alternating electric field may also cause dielectric heating in the ion exchange membrane 140, depending on the composition of the membrane and the frequency at which the electric field alternates.

Due to, among other things, the substantially higher mass of ions compared to electrons, the ions in the ion exchange membrane have a lower mobility compared to the electrons in, e.g., the catalyst structure 140 or the electrically conductive elements 111, 121. This in turn means that the ions will be slower to respond to changes in an applied electric field and that if an applied electric field changes rapidly enough the ions will be substantially unaffected. If the frequency of the alternating electric field is high enough, electrical currents may thus arise in, e.g., the catalyst structure 140 without any substantial alteration of the movements of the ions in the ion exchange membrane. The frequency of the alternating electric field may be selected such that this condition is met.

As an example, the alternating electric field may alternate with a frequency of between 1 kHz and 10 MHz.

With reference to FIG. 1, the feeding means may comprise electrical leads 160 connected to the electrically conductive elements 111, 121, the electrical leads being connected to a power source. The power source may be a power source 150 that is used to drive the electrolysis process, or it may be a second power source.

According to aspects, the variable electromagnetic field may be an alternating magnetic field. The feeding means may then comprise means 410 for generating an alternating magnetic field, as shown in FIG. 4. When an electrically conducting material such as the materials present in the catalyst structure 140 is exposed to an alternating magnetic field, currents are induced in the electrically conducting material. This leads to an increase in temperature.

A means 410 for generating an alternating magnetic field may for example comprise an inductor, i.e., an electrically conducting wire wound into a coil, or an electromagnet comprising an electrically conducting coil and a magnetic core. A means 410 for generating an alternating magnetic field may also be a resonant capacitor array coupled to an electrically conducting coil.

As an example, the means 410 for generating an alternating magnetic field may be arranged to generate a magnetic field with field strengths of tens of kA/m. The frequency of the alternating magnetic field may be between 100 and 10000 kHz. Input parameters such as the current supplied to the coils may be adjusted to achieve these field strengths and frequencies.

In addition to heating effects due to induced currents, some materials undergo more efficient heating when exposed to alternating magnetic fields due to magnetic hysteresis. These materials are referred to herein as magnetic materials and may for example be ferromagnetic, ferrimagnetic, or superparamagnetic materials. If such a magnetic material is incorporated into the electrolyzer this can improve the efficiency of heating via an alternating magnetic field.

Therefore, FIG. 4 also shows the electrolyzer 100 comprising a plurality of magnetic elements 420, each magnetic element comprising magnetic materials.

Magnetic materials may comprise transition metals such as iron, nickel and cobalt. Magnetic materials may also comprise rare earth metals such as scandium, yttrium, neodymium, gadolinium and praseodymium, as well as mixtures or alloys of several rare earth metals and/or transition metals. Magnetic materials may also comprise oxides of transition metals or rare earth metals, such as iron oxide. In particular, superparamagnetic materials may be nanoparticles that comprise transition metals or rare earth metals.

According to aspects, the magnetic elements 420 may be comprised in the catalyst structure 140. As one example, the magnetic elements 420 may be in the form of small particles attached to the catalyst support structure. Such small particles may for example be nanoparticles with a size of less than 100 nm, or preferably less than 50 nm.

As another example, the magnetic elements may be incorporated into the catalyst support structure. As a third example, in cases where the catalyst structure 140 comprises catalyst particles 142, the magnetic elements 420 may also be catalyst particles. In this case, the catalyst particles 140 may comprise ferromagnetic elements such as nickel or iron, or alloys of ferromagnetic elements with elements such as platinum or palladium.

According to other aspects, the magnetic elements 420 may be located in the ion exchange membrane 130, so that the temperature of the membrane is increased when the electrolyzer 100 is exposed to the alternating magnetic field. The parts of the catalyst structure 140 that are closest to the ion exchange membrane 130 contribute more to the electrolysis process compared to parts of the catalyst structure 140 that are further away from the ion exchange membrane 130, as it is easier for protons or hydroxide ions to enter the membrane if the reaction occurs closer to the membrane. If the temperature of the ion exchange membrane 130 is increased, heat will be conducted to nearby parts of the catalyst structure 140, resulting in the desired temperature gradient.

It should be noted that, under normal operation of the electrolyzer, heat will be generated the ion exchange membrane 130 due to resistive heating connected to the ionic conduction in the membrane. Additional heating of the membrane may thus be adjusted so as not to exceed the maximal operating temperature of the ion exchange membrane.

FIG. 6 illustrates a method for introducing a temperature gradient into an electrolyzer 100 as shown in FIGS. 1, 3 and 4. The electrolyzer 100 comprises a first 110 and a second 120 electrode and an ion exchange membrane 130 arranged in-between the first and the second electrode. Each electrode comprises an electrically conductive element 111, 121 and at least one electrode comprises a catalyst structure 140. The catalyst structure 140 comprises an electrically conductive material. The method comprises arranging S1 at least one feeding means 160, 320, 330, 410 to introduce a variable electromagnetic field into the electrolyzer 100. The method further comprises introducing S2 the variable electromagnetic field into the electrolyzer 100 using the feeding means 160, 320, 330, 410, where the variable electromagnetic field is arranged to create a temperature gradient in the electrolyzer 100 by increasing a temperature of the catalyst structure 140.

According to some aspects, the method may include that the variable electromagnetic field is a propagating electromagnetic wave. As an example, the propagating electromagnetic wave can comprise a frequency component between 300 MHz and 300 GHz. As another example, the propagating electromagnetic wave may comprise a frequency component corresponding to a plasmon frequency of the catalyst structure. In particular, the plasmon frequency may be a plasmon frequency of a plurality of catalyst particles comprised in the catalyst structure. If the catalyst structure comprises nanoantennas, the electromagnetic wave may comprise a frequency component corresponding to a plasmon frequency of said nanoantennas.

According to other aspects, the variable electromagnetic field may be a variable magnetic field and the catalyst structure may comprise magnetic elements. In particular, magnetic elements may be incorporated into the catalyst support structure or the catalyst particles.

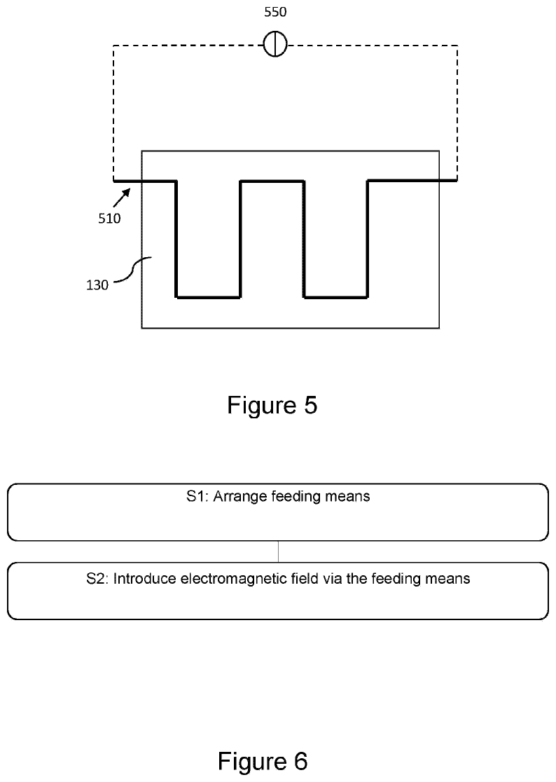

With reference to FIGS. 1 and 5, there is also herein disclosed an electrolyzer 100 comprising a first 110 and a second 120 electrode and an ion exchange membrane 130 arranged in-between the first and the second electrode. Each electrode comprises an electrically conductive element 111, 121. At least one of the electrodes comprises a catalyst structure 140. The ion exchange membrane 130 comprises a heating means arranged to create a temperature gradient in the electrolyzer 100 by increasing a temperature of the ion exchange membrane 130.

As previously mentioned, the parts of the catalyst structure 140 that are closest to the ion exchange membrane 130 contribute more to the electrolysis process compared to parts of the catalyst structure 140 that are further away from the ion exchange membrane 130, as it is easier for protons or hydroxide ions to enter the membrane if the reaction occurs closer to the membrane. To increase the temperature in the parts of the catalyst structure 140 that are closest to the membrane, it is possible to heat the membrane, from which heat will then flow to the catalyst structure 140.

It should be noted that, under normal operation of the electrolyzer, heat will be generated the ion exchange membrane 130 due to resistive heating connected to the ionic conduction in the membrane. Additional heating of the membrane may therefore be adjusted so as not to exceed the maximal operating temperature of the ion exchange membrane.

According to one example, the heating means may be a heating coil 510, as shown in FIG. 5. The heating coil may comprise wires of an electrically conductive material such as a metal. The wires may be embedded in the ion exchange membrane 130, as well as being connected to a power source 550. A power source may for example be a source of AC current, or it may be a battery. Optionally, the heating coil is connected to the power source 150 that is used to drive the electrolysis process.

The material of the heating coil may be a metal, or it may be a material with an electrical conductivity comparable to that of a metal, such as an electrically conducting polymer. According to one example, the heating coil is made of copper. According to another example, the heating coil is made of platinum.

In addition to transporting ions, the ion exchange membrane 130 also serves the purpose of preventing a flow of electrons between the electrodes of the electrolyzer. Thus, when introducing an electrically conductive heating coil into the membrane, it is preferable that a thickness of the heating coil 510 is smaller than a thickness of the ion exchange membrane 130, such that the heating coil 510 may be completely embedded in the ion exchange membrane 130 and not come into contact with the catalyst structures 140 on either side of the membrane.

Here, the thickness of the ion exchange membrane is taken to be the size of the membrane in a direction substantially perpendicular to the electrodes 110, 120. The thickness may be on the order of tens of micrometers, and preferably around 50 micrometers.

The thickness of the heating coil is likewise taken to be the size of the coil in the direction substantially perpendicular to the electrodes 110, 120. This may be equal to a thickness of an electrically conductive wire comprised in the heating coil. As an example, the thickness of the heating coil may be less than 10 micrometers, and preferably around 100 to 150 nanometers.

It should be noted that all methods and devices for introducing a temperature gradient into an electrolyzer described herein can also be used in combination, as will be obvious to a person skilled in the art.

1. An electrolyzer comprising a first and a second electrode and an ion exchange membrane arranged in-between the first and the second electrode, each electrode comprising an electrically conductive element, at least one electrode comprising a catalyst structure comprising an electrically conductive material, the electrolyzer also comprising at least one feeding means, wherein the feeding means is arranged to introduce a variable electromagnetic field into the electrolyze, the variable electromagnetic field being arranged to create a temperature gradient in the electrolyzer by increasing a temperature of the catalyst structure.

2. The electrolyzer according to claim 1, wherein the variable electromagnetic field is a propagating electromagnetic wave.

3. The electrolyzer according to claim 2, wherein the feeding means comprise a microwave applicator, a waveguide, a transmission line, and/or an optical fiber.

4. The electrolyzer according to claim 2, wherein at least one feeding means is positioned in connection to at least one of the electrically conductive elements.

5. The electrolyzer according to claim 2, wherein at least one feeding means is positioned in connection to the ion exchange membrane.

6. The electrolyzer according to claim 2, wherein the propagating electromagnetic wave comprises a frequency component between 300 MHz and 300 GHz.

7. The electrolyzer according to claim 2, wherein the propagating electromagnetic wave is a surface wave.

8. The electrolyzer according to claim 2, wherein the propagating electromagnetic wave comprises a frequency component corresponding to a plasmon frequency of the catalyst structure.

9. The electrolyzer according to claim 8, wherein the catalyst structure comprises catalyst particles and the plasmon frequency is a plasmon frequency of the catalyst particles.

10. The electrolyzer according to claim 8, wherein the catalyst structure comprises a plurality of nanoantennas, and the plasmon frequency is a plasmon frequency of said nanoantennas.

11. The electrolyzer according to claim 1, wherein the variable electromagnetic field is an alternating electric field.

12. The electrolyzer according to claim 11, wherein the feeding means comprise electrical leads connected to the electrically conductive elements, the electrical leads being connected to a power source.

13. The electrolyzer according to claim 1, wherein the variable electromagnetic field is an alternating magnetic field, and the feeding means comprise means for generating an alternating magnetic field.

14. The electrolyzer according to claim 13, wherein the electrolyzer further comprises a plurality of magnetic elements.

15. The electrolyzer according to claim 14, wherein the magnetic elements are comprised in the catalyst structure.

16. The electrolyzer according to claim 15, wherein the catalyst structure comprises catalyst particles and the magnetic elements are catalyst particles.

17. The electrolyzer according to claim 14, wherein the magnetic elements are located in the ion exchange membrane.

18. A method for introducing a temperature gradient into an electrolyzer, the electrolyzer comprising a first and a second electrode and an ion exchange membrane arranged in-between the first and the second electrode, each electrode comprising an electrically conductive element, at least one electrode comprising a catalyst structure comprising an electrically conductive material, the method comprising:
arranging (S1) at least one feeding means to introduce a variable electromagnetic field into the electrolyzer, and
introducing (S2) the variable electromagnetic field into the electrolyzer using the feeding means,
the variable electromagnetic field being arranged to create a temperature gradient in the electrolyzer by increasing a temperature of the catalyst structure.

19. (canceled)

20. (canceled)

21. (canceled)
